(19) United States
(12) Patent Application Publication
(10) Pub. No.: US 2023/0349711 A1
(43) Pub. Date: Nov. 2, 2023

(54) MOVEMENT ROUTE ESTIMATION DEVICE, MOVEMENT ROUTE ESTIMATION METHOD, AND NON-TRANSITORY COMPUTER READABLE MEDIUM

(71) Applicant: Mitsubishi Electric Corporation, Tokyo (JP)

(72) Inventors: Ryoji HATTORI, Tokyo (JP); Seiji OKUMURA, Tokyo (JP); Takayuki KODAIRA, Tokyo (JP); Hirofumi NISHIKAWA, Tokyo (JP); Akito ARAI, Tokyo (JP); Fuminori NAGASAWA, Tokyo (JP); Eiji YAMAMOTO, Tokyo (JP)

(73) Assignee: Mitsubishi Electric Corporation, Tokyo (JP)

(21) Appl. No.: 18/220,444

(22) Filed: Jul. 11, 2023

Related U.S. Application Data
(63) Continuation of application No. PCT/JP2021/008658, filed on Mar. 5, 2021.

(51) Int. Cl. G01C 21/36; G01C 21/34

(52) U.S. Cl. CPC G01C 21/3647; G01C 21/3602; G01C 21/3492

(57) ABSTRACT

A movement route estimation device (50) includes an object search unit (504) and a movement route estimation unit (505). The object search unit (504) searches for, as a search feature value, each feature value of two or more feature values from among a plurality of object feature values, based on a similarity between a feature value corresponding to a movable object, which is an object that has moved in a target space in a target period, and a target feature value. The movement route estimation unit (505) obtains a plurality of route candidates indicating candidates for a corresponding route that corresponds to a route, in the target space, on which the movable object has moved in the target period and a plurality of likelihoods respectively corresponding to the plurality of route candidates, based on a capture time corresponding to the search feature value and a position of presence of an object corresponding to the search feature value at the capture time corresponding to the search feature value, and estimates the corresponding route from the plurality of route candidates, depending on the obtained likelihoods.

### CROSS REFERENCE TO RELATED APPLICATION

This application is a Continuation of PCT International Application No. PCT/JP2021/008658, filed on Mar. 5, 2021, which is hereby expressly incorporated by reference into the present application.

### TECHNICAL FIELD

The present disclosure relates to a movement route estimation device, a movement route estimation method, and a movement route estimation program.

### BACKGROUND ART

In a space where many people gather, such as a station, an airport, a large-scale facility such as a commercial facility, or a city block, there may be a case where means for searching for a specific person is required. As a specific example, if there is a lost child or a wanderer, or separation from an accompanier or the like occurs, it is necessary to perform a person search based on a request from a person who uses the space. In addition, in a case where a user of a shop or service does not appear at a predetermined place by the reservation time or entry time, a case where after a user of a shop has left the shop, an item left by the user or a procedural flaw of the user is found, or the like, it is necessary to search for the user. From the viewpoint of crime prevention, in a case where the position of an escaped shoplifter, groper, assaulter, or the like is identified to make an arrest, a case where the behavior of a primary person of interest is analyzed in a case investigation, or the like, means for searching for a person is required.

In a space where many people gather, it is a common practice to install many network cameras for the purpose of crime prevention. Therefore, consideration is being given to means for extracting features of persons from videos captured by network cameras, and based on the extracted features of persons, automatically searching live videos or recorded videos so as to find out when and by which camera a search target person has been captured. Alive video is also called a real-time video. To search for a person, a person identification process is used in which images in which persons are captured are compared by comparing feature values so as to determine whether the persons captured in the images are the same person.

Patent Literature 1 discloses a method in which when positional relations of cameras and distances between cameras are given, movement of a target person between cameras is estimated using a similarity of appearance features of the target person captured by each camera and a movement destination camera estimation result based on the direction of movement of the target person.

### CITATION LIST

### Patent Literature

Patent Literature 1: WO 2015/098442 A1

### SUMMARY OF INVENTION

### Technical Problem

The method disclosed in Patent Literature 1 is a method that sequentially tracks a movement route of a target person by repeating a process of estimating a camera that has captured the target person in chronological order. Therefore, this method centers on the local estimation process, and a problem is that estimation of the movement route fails if the target person is erroneously identified at a certain time, or if there is omission in identification at a certain time.

An object of the present disclosure is to estimate a movement route of a target person without sequentially tracking the target person.

### Solution to Problem

A movement route estimation device according to the present disclosure uses data managed by a feature management device, and the feature management device treats, as a target feature value, each object feature value of a plurality of object feature values extracted from a plurality of videos captured of part of a target space in a target period, and managing the target feature value in association with a capture time that indicates a time of capture of a video from which the target feature value is extracted, and

the target feature value is a feature value extracted from one of the plurality of videos, and indicating a feature of one object of one or more objects, and

the movement route estimation device includes

an object search unit to search for, as a search feature value, each feature value of two or more feature values from among the plurality of object feature values, based on a similarity between a feature value corresponding to a movable object and the target feature value, the movable object being an object that has moved in the target space in the target period; and

a movement route estimation unit to obtain a plurality of route candidates and a plurality of likelihoods respectively corresponding to the plurality of route candidates, based on a capture time corresponding to the search feature value and a position of presence of an object corresponding to the search feature value at the capture time corresponding to the search feature value, the plurality of route candidates indicating candidates for a corresponding route that corresponds to a route, in the target space, on which the movable object has moved in the target period, and to estimate the corresponding route from the plurality of route candidates, depending on the obtained likelihoods.

### Advantageous Effects of Invention

According to the present disclosure, a plurality of route candidates are obtained based on feature values, and a movement route of a target person is estimated based on a likelihood of each of the obtained route candidates. Therefore, according to the present disclosure, the movement route of the target person can be estimated without sequentially tracking the target person.

### BRIEF DESCRIPTION OF DRAWINGS

FIG. 1 is a figure illustrating an example of a configuration of a movement route estimation system 90 according to Embodiment 1;

FIG. 2 is a figure illustrating an example of a hardware configuration of a movement route estimation device 50 according to Embodiment 1;

FIG. 3 is a flowchart illustrating regular operation according to Embodiment 1;

FIG. 4 is a figure describing a camera relation map according to Embodiment 1;

FIG. 5 is a figure describing a process of creating a camera relation map according to Embodiment 1, where (a) is a figure illustrating a given map and (b) is a figure illustrating a camera relation map corresponding to (a):

FIG. 6 is a flowchart illustrating event operation according to Embodiment 1:

FIG. 7 is a figure describing a process of the movement route estimation device 50 according to Embodiment 1, where (a) is a figure illustrating a setting at execution of loop processing of the first time, (b) is a figure illustrating a state after the execution of loop processing of the first time, and (c) is a figure illustrating a setting at execution of loop processing of the second time;

FIG. 8 is a figure describing a process of the movement route estimation unit 505 according to Embodiment 1, where (a) is a figure illustrating a camera relation map and (b) is a figure illustrating movement costs;

FIG. 9 is a figure describing route candidates according to Embodiment 1, where (a) is a table indicating a search result, (b) is a figure illustrating a route candidate, (c) is a figure illustrating a route candidate, and (d) is a figure illustrating a route candidate; and

FIG. 10 is a figure illustrating an example of a hardware configuration of the movement route estimation device 50 according to a variation of Embodiment 1.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in figures mainly indicate flows of data or flows of processing. “Unit” may be suitably interpreted as “circuit”, “step”, “procedure”, “process”, or “circuitry”.

### Embodiment 1

This embodiment will be described in detail below with reference to the drawings.

***Description of Configuration***

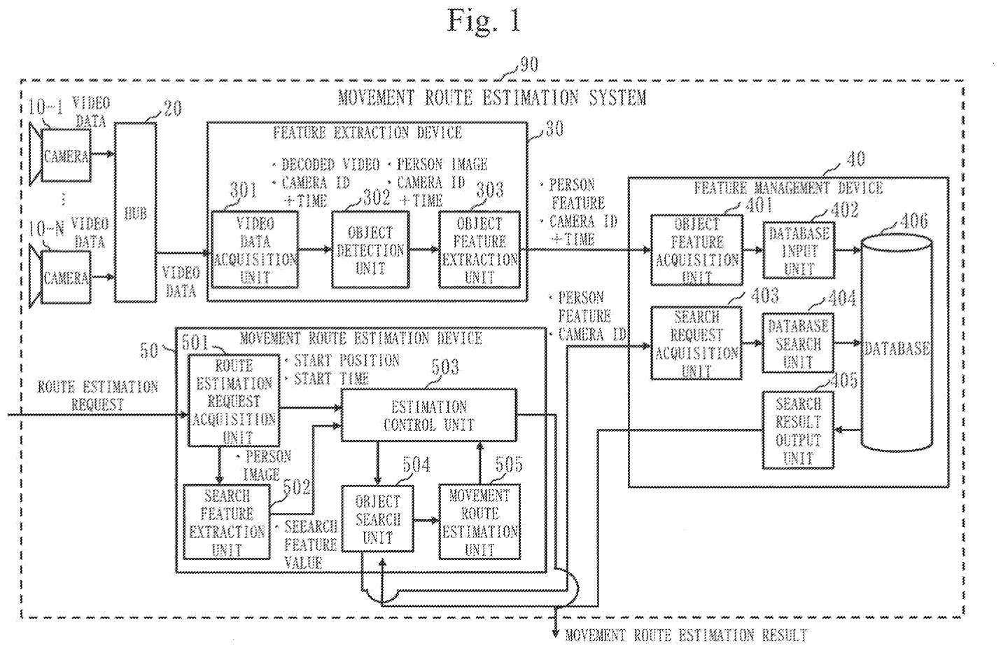

FIG. 1 illustrates an example of a configuration of a movement route estimation system 90. As illustrated in this figure, the movement route estimation system 90 includes cameras 10, a hub 20, a feature extraction device 30, a feature management device 40, and a movement route estimation device 50.

The movement route estimation device 50 is connected with the feature management device 40. The feature management device 40 is connected with the feature extraction device 30. The feature extraction device 30 is connected with each camera 10 via the hub 20.

There are N cameras 10. N is an integer equal to or greater than 2, and “-1” and the like are representations for distinguishing the N cameras 10. Each of a camera 10-1 to a camera 10-N is, typically, an Internet Protocol (IP) camera, and is installed in each place in a target space, which is a space where a movement route is estimated, and captures a video of target objects that are present in the target space. The video captured by each of the cameras 10 is transmitted to the hub 20 via a transmission line such as an IP network. Each of the cameras 10 may be placed without sharing a field of view. That is, in the target space, there may be a blind spot not captured by any of the cameras 10.

In this embodiment, the cameras 10 are assumed to be cameras that transmit compressed video data via an IP network. However, the cameras 10 may be cameras that transmit uncompressed video signals via a coaxial cable, or may be cameras that employ other transmission methods.

The hub 20 has a function of receiving video data delivered by each of the cameras 10 and delivering the received video data to the feature extraction device 30. If a protocol other than IP is used for data delivery from each of the cameras 10, the hub 20 is an aggregation device that supports this protocol. There may be a plurality of hubs 20, and each of the hubs 20 may be connected to only some of the cameras 10.

When each of the cameras 10 is connected to the Internet using a public line and each of the cameras 10 delivers video data to the Internet, the feature extraction device 30 may be connected to the Internet and may receive video data via the Internet. In this case, the Internet is equivalent to the hub 20.

The feature extraction device 30 includes a video data acquisition unit 301, an object detection unit 302, and an object feature extraction unit 303.

The feature extraction device 30 extracts, from an object captured in a video acquired by each of the cameras 10, an object feature value that can be utilized to identify an object and inputs, to the feature management device 40, the extracted object feature value as a set with a camera identification (ID) and a capture time of the camera 10 that has captured the object. The feature extraction device 30 is also called a person feature extraction device. An object is a target whose movement route is to be estimated by the movement route estimation device 50, and is a person, a vehicle, a robot, or an animal, as a specific example.

The feature management device 40 includes an object feature acquisition unit 401, a database input unit 402, a search request acquisition unit 403, a database search unit 404, a search result output unit 405, and a database 406.

The feature management device 40 is a database device to record and manage object feature values. The feature management device 40 has a function of registering, in the database 406 and as a feature value record, a set of an object feature value, a capture camera ID, and a capture time that are input from the feature extraction device 30, and a function of extracting, from the database 406 and based on a search request from the movement route estimation device 50, a feature value record including a person feature value similar to a person feature value included in the search request. The feature management device 40 is also called a person feature management device. The feature management device 40 treats, as a target feature value, each object feature value of a plurality of object feature values extracted from a plurality of videos captured of part of a target space in a target period, and manages the target feature value in association with the capture time that indicates the time of capture of a video from which the target feature value is extracted. The target feature value is a feature value that is extracted from one of the plurality of videos and indicates a feature of one object of one or more objects. Each video of the plurality of videos is a video captured by each of the cameras 10.

The movement route estimation device 50 includes a route estimation request acquisition unit 501, a search feature extraction unit 502, an estimation control unit 503, an object search unit 504, and a movement route estimation unit 505. The estimation control unit 503 is also called a movement route estimation control unit.

Based on a movement route estimation request from a user, the movement route estimation device 50 estimates a movement route of a person of a person image included in the request while controlling the feature management device 40. The movement route estimation device 50 is also called a person movement route estimation device. The movement route estimation device 50 uses data managed by the feature management device 40.

The object search unit 504 searches for, as a search feature value, each feature value of two or more feature values from among a plurality of object feature values, based on a similarity between the target feature value and a feature value corresponding to a movable object that is an object that has moved in the target space in the target period.

The movement route estimation unit 505 obtains a plurality of route candidates and a plurality of likelihoods respectively corresponding to the plurality of route candidates based on a capture time corresponding to the search feature value and a position of presence of an object corresponding to the search feature value at the capture time, and estimates a corresponding route from the plurality of route candidates, depending on the obtained likelihoods. The plurality of route candidates indicate candidates for a corresponding route that corresponds to a route of movement of the movable object in the target space in the target period. Note that the movement route estimation unit 505 may not be able to estimate exactly the same route as the actual movement route of the movable object, and thus the route estimated by the movement route estimation unit 505 is referred to as the corresponding route. The movement route estimation unit 505 may obtain a plurality of realization probabilities respectively corresponding to the plurality of route candidates, based on the capture time corresponding to the search feature value and the position of presence of the object corresponding to the search feature value at the capture time, and obtain the plurality of likelihoods respectively corresponding to the plurality of route candidates, based on the obtained realization probabilities. The movement route estimation unit 505 may obtain the plurality of likelihoods respectively corresponding to the plurality of route candidates, based on a speed assumed as a speed of movement of the movable object on each of a plurality of routes respectively corresponding to the plurality of route candidates. The movement route estimation unit 505 may obtain the plurality of likelihoods respectively corresponding to the plurality of route candidates, based on a similarity between the feature value corresponding to the movable object and the search feature value. The movement route estimation unit 505 may obtain each of the plurality of route candidates, using a camera relation map, which is a graph generated based on a map of the target space and positions of areas captured in each of the plurality of videos. The movement route estimation unit 505 may obtain the plurality of likelihoods respectively corresponding to the plurality of route candidates, based on a movement cost that indicates a cost of movement of the movable object between nodes on the camera relation map.

In FIG. 1, the feature extraction device 30, the feature management device 40, and the movement route estimation device 50 are represented as separate devices, but at least two of these devices may be integrated into one device. Each of the feature extraction device 30 and the feature management device 40 is represented as one device, but each of the feature extraction device 30 and the feature management device 40 may be composed of a plurality of devices. As a specific example, by providing a plurality of feature extraction devices 30 and arranging that some of the cameras 10 are allocated to one of the feature extraction devices 30 and the other cameras 10 are allocated to different ones of the feature extraction devices 30, the feature extraction devices 30 can cope even if there are a huge number of cameras 10. As a specific example, by providing a plurality of feature management devices 40 and distributing the database 406 to these devices, the speed of searching and record storage can also be improved.

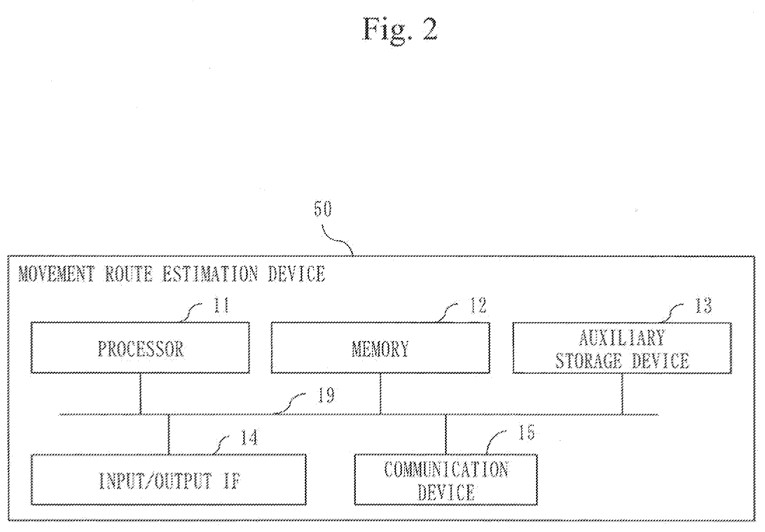

FIG. 2 illustrates an example of a hardware configuration of the movement route estimation device 50 according to this embodiment. The movement route estimation device 50 is composed of a computer. The movement route estimation device 50 may be composed of a plurality of computers.

As illustrated in this figure, the movement route estimation device 50 is a computer that includes hardware such as a processor 11, a memory 12, an auxiliary storage device 13, an input/output interface (IF) 14, and a communication device 15. These hardware components are connected as appropriate through a signal line 19.

The processor 11 is an integrated circuit (IC) that performs operational processing, and controls the hardware included in the computer. The processor 11 is, as a specific example, a central processing unit (CPU), a digital signal processor (DSP), or a graphics processing unit (GPU).

The movement route estimation device 50 may include a plurality of processors as an alternative to the processor 11. The plurality of processors share the role of the processor 11.

The memory 12 is, typically, a volatile storage device. The memory 12 is also called a main storage device or a main memory. The memory 12 is, as a specific example, a random access memory (RAM). Data stored in the memory 12 is saved in the auxiliary storage device 13 as necessary.

The auxiliary storage device 13 is, typically, a non-volatile storage device. The auxiliary storage device 13 is, as a specific example, a read only memory (ROM), a hard disk drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. The input/output IF 14 is, as a specific example, a Universal Serial Bus (USB) terminal. The input device is, as a specific example, a keyboard and a mouse. The output device is, as a specific example, a display.

The communication device 15 is a receiver and a transmitter. The communication device 15 is, as a specific example, a communication chip or a network interface card (NIC).

Each unit of the movement route estimation device 50 may use the communication device 15 as appropriate when communicating with other devices or the like. Each unit of the movement route estimation device 50 may accept data via the input/output IF 14, or may accept data via the communication device 15.

The auxiliary storage device 13 stores a movement route estimation program. The movement route estimation program is a program that causes a computer to realize the functions of each unit included in the movement route estimation device 50. The movement route estimation program is loaded into the memory 12 and executed by the processor 11. The functions of each unit included in the movement route estimation device 50 are realized by software.

Data used when the movement route estimation program is executed, data obtained by executing the movement route estimation program, and so on are stored in a storage device as appropriate. Each unit of the movement route estimation device 50 uses the storage device as appropriate. As a specific example, the storage device is composed of at least one of the memory 12, the auxiliary storage device 13, a register in the processor 11, and a cache memory in the processor 11. Data and information may have substantially the same meaning. The storage device may be independent of the computer.

The functions of the memory 12 and the auxiliary storage device 13 may be realized by other storage devices.

Any program described in this specification may be recorded in a computer readable non-volatile recording medium. The non-volatile recording medium is, as a specific example, an optical disc or a flash memory. Any program described in this specification may be provided as a program product.

The hardware configuration of each of the feature extraction device 30 and the feature management device 40 may be substantially the same as the hardware configuration of the movement route estimation device 50.

***Description of Operation*** A procedure for operation of the feature extraction device 30 is equivalent to a feature extraction method. A program that realizes the operation of the feature extraction device 30 is equivalent to a feature extraction program. A procedure for operation of the feature management device 40 is equivalent to a feature management method. A program that realizes the operation of the feature management device 40 is equivalent to a feature management program. A procedure for operation of the movement route estimation device 50 is equivalent to a movement route estimation method. A program that realizes the operation of the movement route estimation device 50 is equivalent to the movement route estimation program.

Operation of the movement route estimation system 90 in this embodiment will be described below. In the following description, an object is assumed to be a person for convenience of description, but the term “person” may be interpreted as other objects as appropriate. Main operation of the movement route estimation system 90 includes regular operation and event operation. The regular operation is operation to collect person feature values by the feature extraction device 30 and the feature management device 40. The event operation is operation, in which a request from a user serves as a trigger, to estimate a movement route of a person by the movement route estimation device 50 and the feature management device 40.

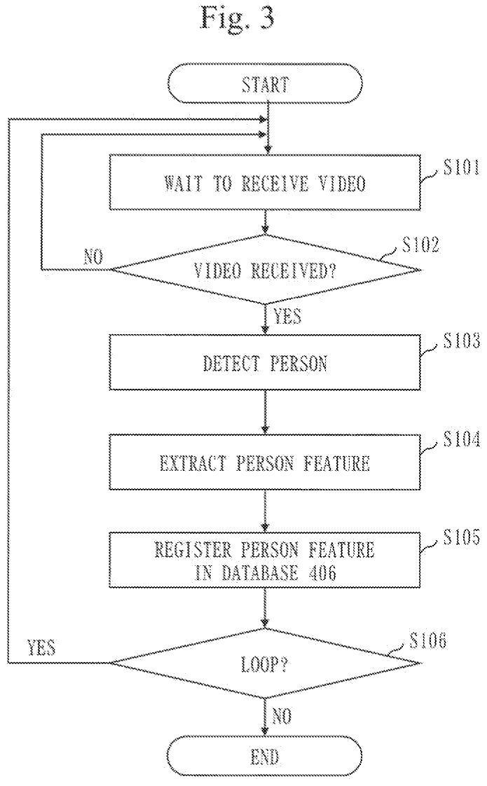

FIG. 3 is a flowchart illustrating an example of the regular operation performed by the feature extraction device 30 and the feature management device 40. Referring to this figure, the regular operation will be described.

(Step S101)

After the feature extraction device 30 starts up, the video data acquisition unit 301 waits to receive video data from the camera 10 via the hub 20. The feature management device 40 may be constantly active, or may be started and stopped repeatedly as appropriate.

(Step S102)

When the video data acquisition unit 301 has received video data from the camera 10, the video data acquisition unit 301 decodes the received video data, and outputs the decoded video data as decoded data to the object detection unit 302. At this time, the video data acquisition unit 301 acquires the camera ID of the camera 10 that has delivered the video data, and outputs the acquired camera ID together with the video data. The video data acquisition unit 301 also outputs a capture time corresponding to the video data together with the video data. The capture time may be a time stamp recorded by the camera 10, or may be a time of reception of the video data by the video data acquisition unit 301. Some frames of the video data may be provided with no corresponding capture time.

As a specific example, the video data acquisition unit 301 pre-stores, within the feature extraction device 30, a table indicating relations between the IP addresses and camera IDs of the cameras 10, and refers to this table to acquire the camera ID. Alternatively, the video data acquisition unit 301 may use the IP address of the camera 10 as the camera ID. The camera ID may be any information, provided that it is information that can associate each of the cameras 10 itself and video data transmitted from each of the cameras 10.

If the video data acquisition unit 301 outputs the decoded data and so on to the object detection unit 302, the feature extraction device 30 proceeds to step S103.

(Step S103)

The object detection unit 302 detects a person captured in the video of the decoded data output by the video data acquisition unit 301. The object detection unit 302 outputs, to the object feature extraction unit 303, a detection result, which is a result of detecting the person, a capture time, which is a time at which the detected person was captured, and the camera 1D of the camera 10 that has captured the detected person.

The method by which the object detection unit 302 detects a person may be a method using an image analysis technique such as the histogram of oriented gradients (HoG), or may be a method using a machine learning approach such as Convolutional Neural Network (CNN), Faster Region-based Convolutional Neural Network (Faster R-CNN), or Single Shot Detector (SSD).

A target of extraction by the object detection unit 302 needs to match a target from which a feature value is to be extracted by the object feature extraction unit 303 in a later step. As a specific example, if the object feature extraction unit 303 extracts a feature value corresponding to a whole-body image of a person, the object detection unit 302 needs to detect a whole-body image of a person. If the object feature extraction unit 303 extracts a feature value corresponding to the face of a person, the object detection unit 302 needs to detect the face of a person. If the object feature extraction unit 303 extracts feature values based on consecutive frames, such as in a case where the object feature extraction unit 303 extracts feature values corresponding to a motion of a person, the object detection unit 302 needs to detect the same person captured in each frame of the consecutive frames.

The object detection unit 302 may output, as a detection result, an image which is clipped from the video of the decoded data and in which the detected person is captured, or may output a set of the video of decoded data from which a person is detected and information indicating the position of the detected person in the video. If the object feature extraction unit 303 has means for accessing the recorded video of the decoded data, the object detection unit 302 may output, as a detection result, a set of information that can be used to identify a frame number of the recorded video of the decoded data and information indicating the position of the detected person in the video corresponding to the frame number.

(Step S104)

The object feature extraction unit 303 extracts a person feature value from the detection result output by the object detection unit 302. Person feature values that are extracted by the object feature extraction unit 303 are feature values used to calculate a similarity between persons corresponding to the person feature values, and are equivalent to object feature values. As a specific example, person feature values are values indicating features that can be verbalized, such as clothing of a person, a color and shape of an article belonging to a person, height and shape of a person, gender of a person, or an estimated age of a person, or are values indicating image features such as HoG. Person feature values may be vector data obtained by converting features of the face of a person into a comparable form, as typified by a face recognition technique, or may be vector data obtained by converting features of the whole body of a person into a comparable form. When a detection result of detecting the same person captured in each frame of consecutive frames is input, the object feature extraction unit 303 may use a gait feature, which is a feature of the manner of walking of the detected person, or the like. As a specific example, the gait feature is at least one of a period and width of motion of the arms and legs of the person, a period and width of motion of the upper body of the person, proportion of the person, and attitude of the person. The object feature extraction unit 303 may extract, from each of a plurality of frames, a feature value that can be extracted from a single frame, and use, as a feature value, information in which feature values extracted from individual frames are assembled.

The object feature extraction unit 303 outputs, to the object feature acquisition unit 401, the obtained person feature value together with the capture time and the camera ID that are input from the object detection unit 302.

(Step S105)

The object feature acquisition unit 401 waits for input of data from the feature extraction device 30, and when data of the person feature value and so on is input from the feature extraction device 30, outputs the input data to the database input unit 402.

Based on the person feature value, the camera ID, and the capture time that are input from the object feature acquisition unit 401, the database input unit 402 creates a feature value record and registers the created feature value record in the database 406. The feature value record is also called a person feature value record.

The feature value record is a record including at least information indicating each of the person feature value, the camera ID, and the capture time. The person feature value is the person feature value extracted by the object feature extraction unit 303. The camera ID is the camera ID input as a set with the person feature value from the object feature extraction unit 303. The capture time is the capture time input as a set with the person feature values from the object feature extraction unit 303.

With regard to deletion of a feature value record registered in the database 406, the database input unit 402 may automatically delete a feature value record older than a fixed time among the feature value records registered in the database 406, or may overwrite an old feature value record among the feature value records registered in the database 406 so as to add a new feature value record to the database 406, or may delete a feature value record in the database 406 according to other rules.

(Step S106)

When the database input unit 402 has completed writing the feature value record in the database 406, the movement route estimation system 90 returns to step S101.

Next, a process of tracking a person by the movement route estimation device 50 and the feature management device 40 will be described.

A “camera relation map” will be described.

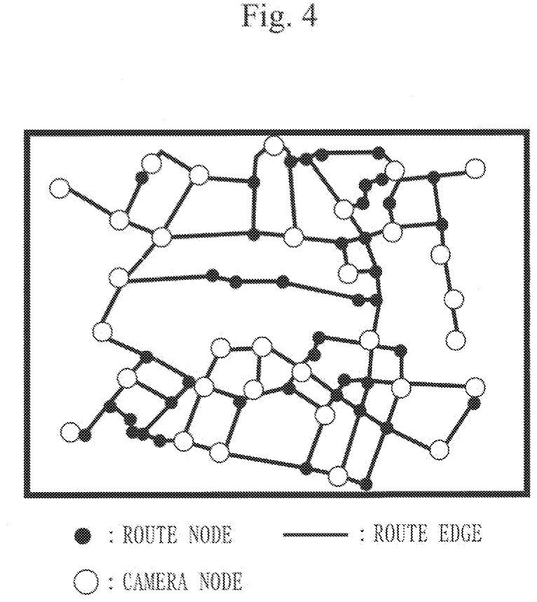

FIG. 4 illustrates a specific example of the camera relation map. As illustrated in FIG. 4, the camera relation map is a map that indicates installation positions of the cameras 10 and adjacency relations between the cameras 10. In the specific example illustrated in FIG. 4, the camera relation map is a map represented by a graph with the installation positions of the cameras 10 as “camera nodes” and adjacency relations between the cameras 10 as “route edges” and “route nodes”.

The “camera nodes” are nodes corresponding to the cameras 10, and each camera node includes the installation position of the corresponding camera 10 and ID information that allows the camera node to be associated with the corresponding camera 10. The position of a “camera node” may be a point within the capture range of each of the cameras 10. The position of a “camera node” corresponds to a position of areas captured in each of the plurality of videos.

The “route nodes” are nodes placed at positions corresponding to corners or branch points in routes when movement routes between the cameras 10 are represented by the “route edges”. Each route node includes information indicating a corner or position information of a branch point corresponding to each route node. A corner may indicate a curve.

The “route edges” are edges indicating adjacency relations of the “camera nodes” and the “route nodes”. A movement route between the cameras 10 is a route that traces each route edge and each route node that exist between the cameras 10. In the following description, the route edges are undirected edges, but the route edges may be directed edges and a constraint such as one-way may be represented by the route edges. For each edge, a movement cost when a person moves between the nodes positioned at both ends of the edge is defined.

The movement cost may be the Euclidean distance between the nodes positioned at both ends of the edge, or may be a numerical value expressing ease of movement on the route corresponding to the edge. The more easily a person can move on the route corresponding to the edge, the lower the value of the movement cost corresponding to the edge.

This embodiment is described using the camera relation map represented by a graph as illustrated in FIG. 4, but the camera relation map may represent adjacency relations between the cameras 10 by an adjacency matrix. When the camera relation map is represented by an adjacency matrix, the adjacency matrix may represent the movement costs between the cameras 10.

A specific example of creating a camera relation map will be described. In the following, it is assumed that the movement route estimation device 50 creates a camera relation map. However, another device may create a camera relation map in place of the movement route estimation device 50, and the created camera relation map may be input to the movement route estimation device 50.

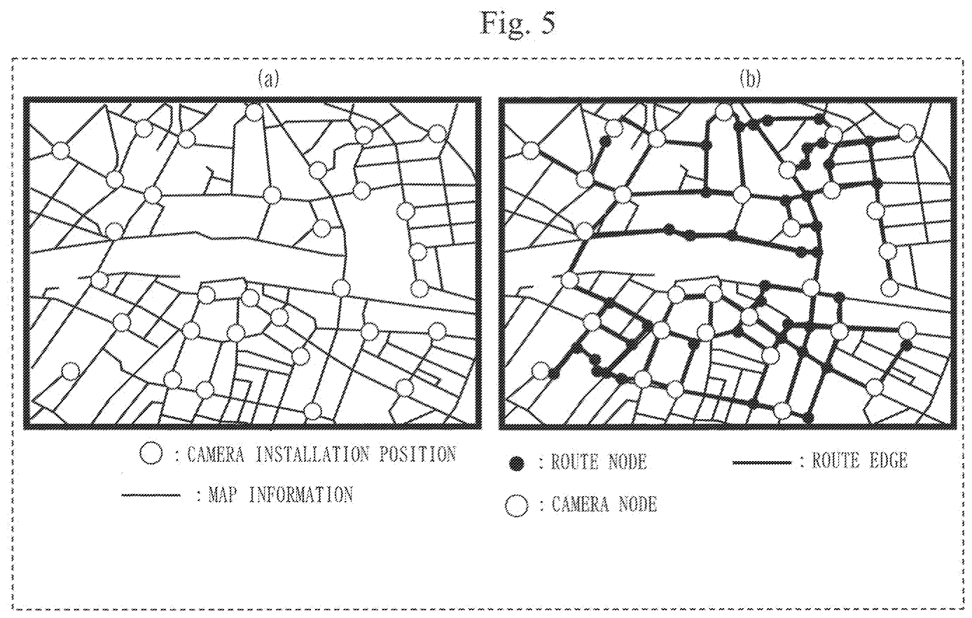

FIG. 5 is a figure describing a specific example of creating a camera relation map. As illustrated in (a) of FIG. 5, a case will be considered where a map indicating the installation positions of the cameras 10 in the target space and roads and passages in the target space is given in advance. In this case, the movement route estimation device 50 regards the roads and passages on the map as routes on which a person can move, and obtains the shortest route between each pair of adjacent cameras 10 by a route search, and treats the obtained shortest route as the route between each pair of adjacent cameras 10.

As illustrated in (b) of FIG. 5, the movement route estimation device 50 sets camera nodes at the installation positions of the cameras 10, sets route nodes at corners and branch points in routes, and creates each route edge by appropriately connecting a camera node and a camera node that exist on the route between each pair of adjacent cameras 10 or appropriately connecting a camera node and a route node that exist on the route. The movement route estimation device 50 also obtains a movement cost corresponding to each route edge according to a predetermined definition. If a person appears in a video captured at a certain time by the camera 10 corresponding to a certain camera node, the movement route estimation device 50 may regard the person as having been present at the position of the certain camera node at the certain time.

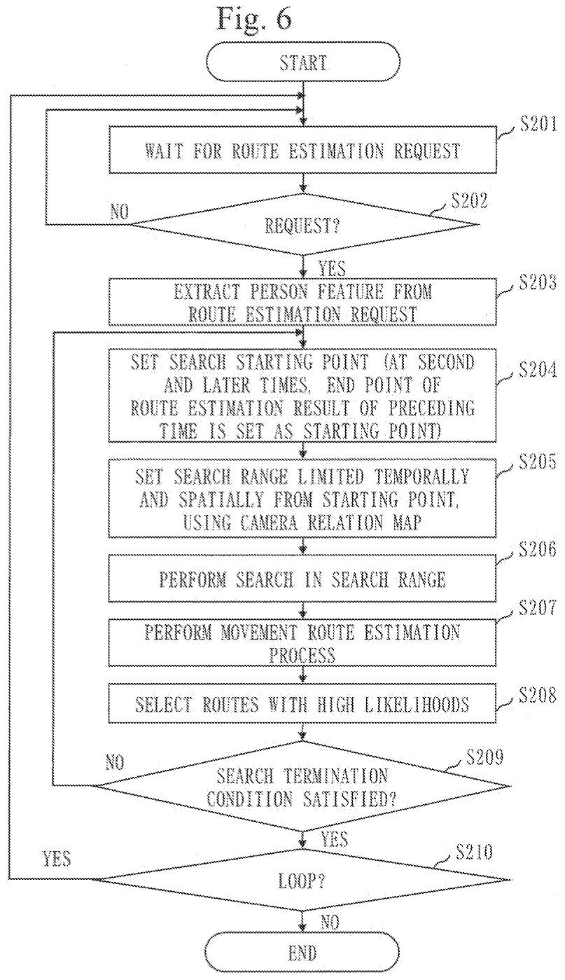

FIG. 6 is a flowchart illustrating an example of the event operation by the movement route estimation device 50 and the feature management device 40. Referring to this figure, the event operation will be described.

(Step S201)

After the movement route estimation device 50 is started, the route estimation request acquisition unit 501 waits to receive a request message. The request message is data input by a user, and is also called a route estimation request message. As a specific example, the request message includes information indicating information I1 to information I3 described below. In the following, it is assumed that the request message includes information indicating the information I1 to the information I3, unless otherwise specified.

Information I1: an image showing an estimation target person whose route is to be estimated

Information I2: information corresponding to a spatial starting point of route estimation

Information I3: information corresponding to a temporal starting point of route estimation

The information I1 needs to be an image from which a person feature value to be used when searching for the estimation target person can be extracted, and may be an image captured by the camera 10 or may be an image not captured by the camera 10. The estimation target person may also be called a search target person. As a specific example, if a person feature value corresponding to a color of an item, clothing, and the like of the estimation target person is used when searching for the estimation target person, the information I1 needs to be a color image. If a person feature value corresponding to a feature of the face of the estimation target person is used when searching for the estimation target person, the information I1 needs to be a face image that satisfies a condition for allowing the person feature value to be extracted. If a person feature value corresponding to a whole-body image of the estimation target person is used when searching for the estimation target person, the information I1 needs to be a whole-body image that satisfies a condition for allowing the person feature value to be extracted. The information I1 may be a set of images. As a specific example, if the information I1 needs to be a face image, a whole-body image, or the like, the information I1 may be a set of images of the estimation target person captured from different angles, or may be a set of images obtained by capturing the estimation target person by changing the clothing of the estimation target person in a variety of ways.

The information I2 and the information I3 are information used to identify the starting point of route estimation. As a specific example, if the information I1 is an image captured using one of the cameras 10, the information I2 may be information indicating the camera ID of this camera 10, and the information I3 may be information indicating the capture time of capturing this image. The information I2 and the information I3 may be information indicating a place and a time corresponding to the estimation target person that are estimated based on a statement of a person who has seen the estimation target person or the like, and may be any electronic log information associated with the estimation target person, such as IC card touch information, two-dimensional code reading information, or a beacon reception record.

(Step S202)

Upon receiving the request message, the route estimation request acquisition unit 501 outputs the information I1 included in the request message to the search feature extraction unit 502, and outputs the information I2 and the information I3 included in the request message to the estimation control unit 503.

In the request message, the information I1 may be a person feature value that has been extracted. If the route estimation request acquisition unit 501 receives a person feature value as the information I1, step S203 is skipped.

(Step S203)

The search feature extraction unit 502 extracts, from the information I1, a search target feature value, which is a person feature value to be used to search for a person corresponding to the estimation target person indicated in the information I1, and outputs the extracted search target feature value to the estimation control unit 503. It is assumed that the search target feature value extracted by the search feature extraction unit 502 is a person feature value of the same kind as a person feature value extracted by the object feature extraction unit 303. If the information I1 includes a plurality of images, the search feature extraction unit 502 extracts a search target feature value from each image of the plurality of images.

(Step S204)

The estimation control unit 503 determines a starting position and a starting time of a search for the person, based on the information indicated by the information I2 and the information I3 input from the route estimation request acquisition unit 501. The starting position is the position of start of the search, and the starting time is the time of start of the search. As a specific example, if the information I2 is information indicating the camera ID, the estimation control unit 503 treats the position of the camera 10 corresponding to this camera ID as the starting position.

The search will be described specifically when describing step S206.

(Step S205)

The estimation control unit 503 sets a search range that is limited temporally and spatially from the starting point. Note that the starting point is a general term for the starting position and the starting time, and a range limited spatially in the search range is a search target area, and a range limited temporally in the search range is a search target time. The search target time is equivalent to a target time period. The estimation control unit 503 outputs the camera ID of each camera 10 present in the search target area, the search target time, and the search target feature value to the object search unit 504.

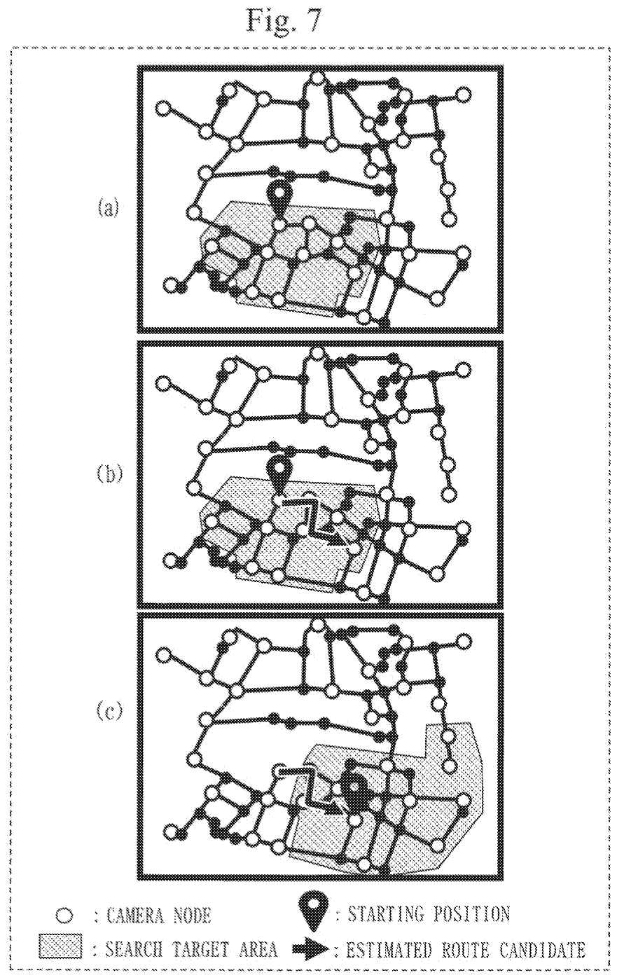

FIG. 7 is a figure describing, using a specific example, a process of searching for a person by the movement route estimation device 50. In (a) of FIG. 7, a situation is indicated where the estimation control unit 503 has set, as the search target area, an area including each camera 10 whose distance from the starting position is within a predetermined value. In this case, the distance from the starting position may be a direct distance from the starting position, or may be a distance defined using the movement cost between the cameras 10 defined by the camera relation map. The estimation control unit 503 also sets, as the search target time, a time of a predetermined duration from the starting time. When setting the search target area and the search target time, the estimation control unit 503 may use an average moving speed or the like of the person to calculate one of the ranges based on the other one of the ranges. The search target time may include a time earlier than the starting time.

(Step S206)

The object search unit 504 controls the feature management device 40 to perform a person search, using the camera ID, the search target time, and the search target feature value that are input from the estimation control unit 503.

The object search unit 504 transmits a search request including the camera ID, the search target time, and the search target feature value to the feature management device 40.

The search request acquisition unit 403 receives the search request transmitted by the object search unit 504, and outputs the camera ID, the search target time, and the search target feature value included in the received search request to the database search unit 404.

Based on the data output by the search request acquisition unit 403, the database search unit 404 creates a search query, which is an instruction with the search target feature value as a search key and conditions regarding the camera ID and the search target time as search conditions. The database search unit 404 also uses, as a search condition, the condition that a degree of matching between the search target feature value included in the search query and the person feature value of a feature value record in the database 406 is greater than or equal to a predetermined threshold value. A different value may be used as the predetermined threshold value depending on the type of the person feature value. The database search unit 404 transmits the created search query to the database 406.

When each of the search target feature value and the person feature value is composed of a combination of pieces of attribute information, the database search unit 404 calculates a similarity between the search target feature value and the person feature value based on a degree of matching between a feature value corresponding to each attribute of the search target feature value, which is a search key, and a feature value corresponding to each attribute of the person feature value of each feature value record included in the database 406, as a specific example. The combination of pieces of attribute information is, as a specific example, a combination of age group, gender, body type, color of clothing, and the like. When the person feature value is composed of a multi-dimensional vector that allows the distance between person feature values to be calculated, the similarity is calculated based on the distance between vectors, which are person feature values. The similarity in this case is calculated using a formula that defines the similarity so that the smaller the distance, the higher the similarity.

The database 406 searches the database 406 in accordance with the search query received from the database search unit 404, creates a search result from a feature value record that matches the search conditions indicated by the search query, and outputs the created search result to the search result output unit 405. The search result is a list of 0 to multiple elements that match the search conditions. Each element of the list includes at least information indicating a query similarity, a camera ID, and a capture time. The query similarity is the similarity between the searched person and a person corresponding to the search query. The query similarity can be regarded as the reliability of the search result. The camera ID is the camera ID of the camera 10 that has captured the searched person. The capture time is the time of capturing the searched person by the camera 10.

The search result output unit 405 receives the search result from the database 406, and transmits the received search result to the movement route estimation device 50.

The object search unit 504 receives the search result from the feature management device 40, and outputs the received search result to the movement route estimation unit 505.

By the process of this step, the object search unit 504 acquires a list of data corresponding to a person resembling the estimation target person among persons captured by the cameras 10 in the search target area in the search target time. The data included in this list may include data corresponding to another person resembling the estimation target person in addition to data corresponding to the estimation target person.

(Step S207)

In this step, the movement route estimation unit 505 generates various route candidates Rₜ, and obtains a likelihood Lₜ of each of the generated route candidates Rₜ.

First, the movement route estimation unit 505 uses the search result input from the object search unit 504 to extract at least some elements of the search result, and arranges the extracted elements of the search result in chronological order so as to estimate a movement route of the estimation target person.

A movement route estimation process will be described in detail below.

First, the movement route estimation unit 505 obtains, as preliminary information in movement route estimation, a movement cost between adjacent cameras 10. The movement cost between adjacent cameras 10 is a value obtained by adding up the movement costs of all route edges existing in the movement route from one of the cameras 10 to the other one of the cameras 10 on the camera relation map. The movement route estimation unit 505 may obtain a route between the cameras 10 with the minimum movement cost as a movement route by a graph search, and when obtaining a movement route, may take into consideration a constraint that a frequently used route should be passed.

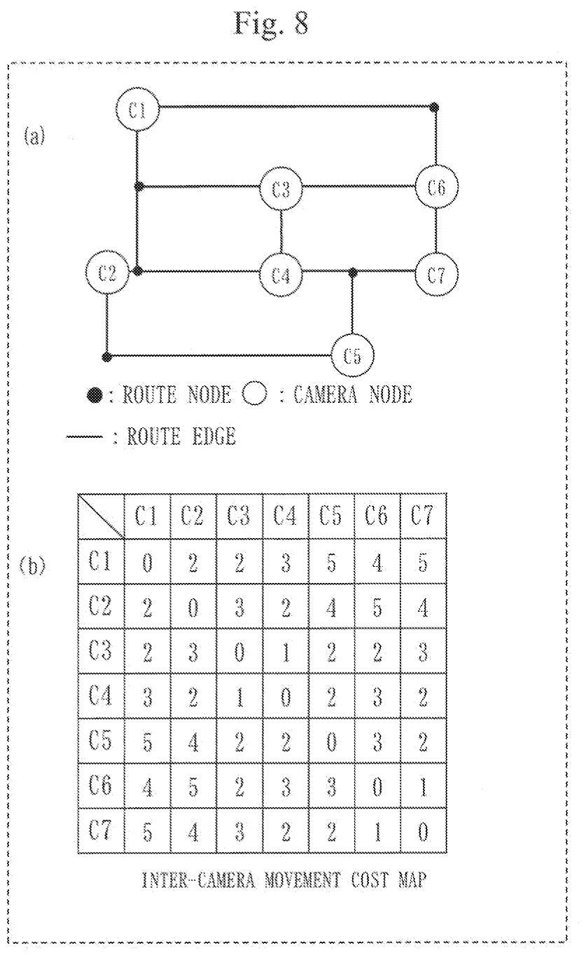

FIG. 8 is a figure describing a process of obtaining a movement cost by the movement route estimation unit 505. Note that (a) of FIG. 8 illustrates a camera relation map and (b) of FIG. 8 illustrates a result of comprehensively obtaining movement costs between adjacent cameras 10 in (a) of FIG. 8. Each of C1 to C7 is a camera ID.

A case will be considered where the camera relation map and the movement costs as indicated in FIG. 8 are given, and a person search result within a fixed time range and within a predetermined area are given as input. In this case, the movement route estimation unit 505 extracts at least some elements of the search result and arranges the extracted elements of the search result in chronological order so as to obtain route candidates. The route candidates are candidates for the movement route of the estimation target person.

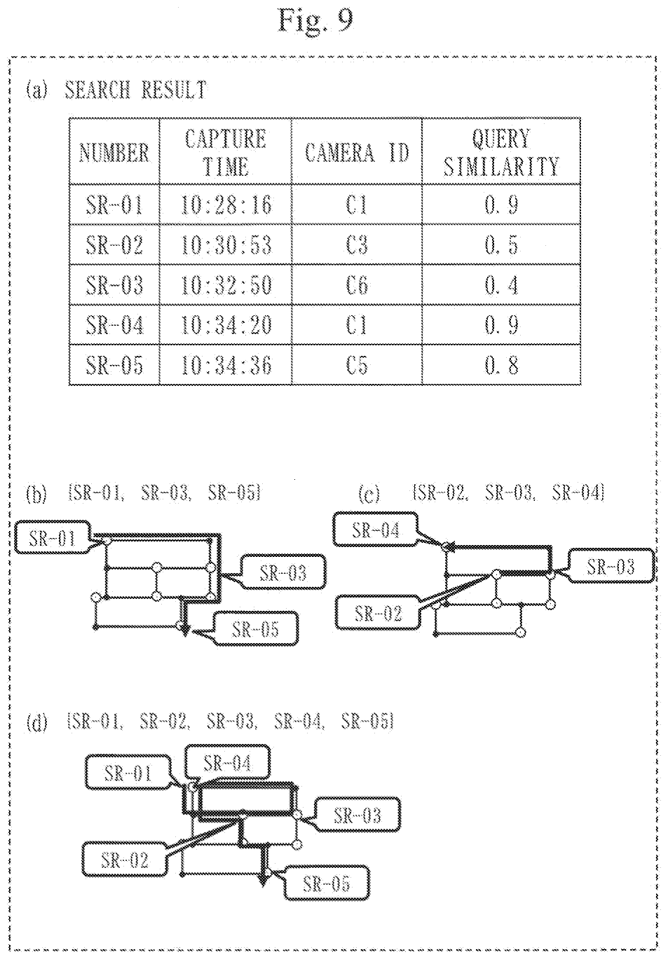

FIG. 9 is a figure describing route candidates. As a specific example, it is assumed that when the search result is composed of five elements, SR-01 to SR-05, as indicated in (a) of FIG. 9, the movement route estimation unit 505 has obtained three different candidates indicated in (b) of FIG. 9, (c) of FIG. 9, and (d) of FIG. 9. The route candidate indicated in (b) of FIG. 9 is a route obtained by extracting three elements {SR-01, SR-03, SR-05} from the search result. This route is a route obtained by connecting the positions of the cameras 10 corresponding to the camera IDs of the extracted elements in chronological order. In the routes indicated in FIG. 9, each route between the cameras 10 is the shortest route between the cameras 10 in the camera relation map. However, it is assumed that a route candidate obtained by the movement route estimation unit 505 includes at least information indicating the order in which the estimation target person has moved between the cameras 10, and estimation of a movement route between the cameras 10 where the estimation target person has not been observed is processed selectively.

As a specific example, when the movement route estimation unit 505 extracts {SR-02, SR-03, SR-04}, the movement route estimation unit 505 obtains the route candidate indicated in (b) of FIG. 9, and when the movement route estimation unit 505 extracts {SR-01, SR-02, SR-03, SR-04, SR-05}, the movement route estimation unit 505 obtains the route candidate indicated in (c) of FIG. 9.

It is assumed here that the movement costs between the cameras 10 indicated in (b) of FIG. 8 are values indicating that a movement time of about one minute is required per movement cost “1”. In this case, as a specific example, the movement cost from Camera C1 to Camera C5 is 5, that is, it takes about five minutes from Camera C1 to Camera C5, but a time gap between the capture time of SR-04 and the capture time of SR-05 is 16 seconds. Therefore, a route candidate including both SR-04 and SR-05 is a route with an extremely low realization probability, and it is inferred that at least one of these results has erroneously identified a person different from the estimation target person.

Each of SR-02 and SR-03 has a low query similarity, that is, has low reliability. It is also considered that a route candidate including many elements with low reliability is highly likely to be different from the correct route. Therefore, among the route candidates indicated in FIG. 9, the route candidate indicated in (b) of FIG. 9 is considered to be most likely to be the correct route.

The movement route estimation unit 505 analyzes the route candidates as described above. The route estimation process performed by the movement route estimation unit 505 will be specifically described below.

First, a search result list S, which is a list of a search result and is an input to the movement route estimation unit 505, is expressed as indicated in [Formula 1].

S[ ]={s₀,s₁, . . . ,s_{N-1}} [Formula 1]

S[ ] is an array, and N is the number of elements in the array, that is, the number of elements of the search result, where s₀ to s_{(N-1)} indicate the elements of the search result. The elements of the search result list S are arranged in ascending order of the “capture time” of each element.

A route candidate is expressed by an array Rₜ as indicated in [Formula 2]. The array Rₜ is also a route candidate Rₜ.

Rₜ[ ]={S[Fₜ[0]], . . . ,S[Fₜ[Mₜ−1]]} [Formula 2]

An array Fₜ is an array obtained by extracting any Mₜ (1≤Mₜ≤N) numbers from N numbers of 0 to N−1 and arranging the extracted numbers in ascending order. That is, there are a maximum of 2^{N}-1 types of the array Fₜ, and t is a serial number indicating a type of the array Fₜ. The range allowed for t is not fixed, and the maximum value of t is up to 2^{N}-1. Mₜ indicates the number of elements in the array Fₜ. Based on the above, the array Rₜ is an array generated by extracting any Mₜ elements from the search result list S and arranging the extracted elements while maintaining the order of the extracted elements in the search result list S.

If the starting point determined by the estimation control unit 503 is known, the movement route estimation unit 505 may include an element of the search result corresponding to the starting point of route estimation in the search result list S. In this case, when the element of the search result corresponding to this starting point is s_{Start}, the movement route estimation unit 505 forms each array Fₜ so that each array Fₜ invariably includes s_{Start}.

When a route candidate is expressed as described above, a likelihood Lₜ of the route candidates Rₜ is defined as indicated in [Formula 3].

$${L}_{t} = α {LS}_{t} + β {LR}_{t} \qquad [ Formula 3 ]$$

$${LS}_{t} = {\sum }_{k = 0}^{{M}_{t} - 1} {PS}_{t} ( k ) / {M}_{t} \qquad [ Formula 4 ]$$

$${LR}_{t} = {\sum }_{k = 0}^{{M}_{t} - 1} {PR}_{t} ( k ) / {M}_{t} \qquad [ Formula 5 ]$$

The likelihood Lₜ is a weighted sum of a likelihood component LSₜ calculated based on a query similarity of each element of the search result included in the route candidate Rₜ and a likelihood component LRₜ calculated based on a movement realization probability between each pair of elements of the search result. A movement realization probability is also called a realization probability, and is also called an inter-camera movement realization probability. α and β are coefficients of the weighted sum. LSₜ is an average value of outputs of a function PSₜ(k) that extracts a query similarity from the search result. LRₜ is an average value of outputs of a function PRₜ(k) that extracts a movement realization probability.

Alternatively, as indicated in [Formula 6], the likelihood Lₜ may be a value obtained by multiplying a product of the likelihood component LSₜ calculated based on the query similarity of each element of the search result included in the route candidate Rₜ and the likelihood component LRₜ calculated based on the movement realization probability between each pair of elements of the search result by a predetermined coefficient C or a predetermined formula C. As indicated in [Formula 7], the likelihood components LRₜ calculated based on the movement realization probability may be a numerical value constituted by a geometric mean of PRₜ(k).

$${L}_{t} = C \times {LS}_{t} \times {LR}_{t} \qquad [ Formula 6 ]$$

$${LR}_{t} = {( {\prod }_{k = 0}^{{M}_{t} - 1} {PR}_{t} ( k ) )}^{\frac{1}{{M}_{t}}} \qquad [ Formula 7 ]$$

The function PSₜ(k) is defined as indicated in [Formula 8], and the function PRₜ(k) is defined as indicated in [Formula 9].

PSₜ(k)=[query similarity included in Rₜ[k]] [Formula 8]

PRₜ(k)=[movement realization probability of Rₜ[k]] [Formula 9]

The function PSₜ(k) is a query similarity corresponding to the k-th element of the route candidate Rₜ.

The function PRₜ(k) is a function that calculates and outputs a probability of realization of movement from the position of the camera 10 corresponding to the camera ID of Rₜ[k−1] to the position of the camera 10 of the camera ID of Rₜ[k], based on the capture times and the camera IDs respectively corresponding to Rₜ[k−1] and Rₜ[k]. If k=0, the movement route estimation unit 505 outputs a predetermined constant value as the value of Rₜ[k].

The movement realization probability will now be described. The movement realization probability from Camera A to Camera B is a value that expresses, using a probability, a possibility of the estimation target person being able to move from the position of Camera A to the position of Camera B within a time length T when the time length T is given.

A specific example of a method for calculating the movement realization probability will be described. When the minimum movement cost from Camera A to Camera B is D and the average movement speed (=movement cost/movement required time) of the estimation target person is V, the time required for the estimation target person to move from Camera A to Camera B is D/V. Therefore, the movement route estimation unit 505 may regard movement as impossible if D/V exceeds T, and regard movement as possible if D/V is equal to or smaller than T A movement realization probability pr in this example can be expressed with D and T as arguments, as indicated in [Formula 10].

$$pr ( D , T ) = \{ \begin{matrix}1 & \frac{D}{V} \leq T \\ 0 & \frac{D}{V} > T\end{matrix} \qquad [ Formula 10 ]$$

Taking into consideration that the movement speed of the estimation target person fluctuates, the movement route estimation unit 505 may express the movement realization probability using a function that approaches 1 as D/V approaches T even when T is below D/V.

A case will also be considered where in addition to the average of the movement speed of the estimation target person, the variance of the movement speed is also known. In this case, the movement route estimation unit 505 may assume that the movement speed is distributed according to the normal distribution determined by this average and this variance, calculate a speed D/T that needs to be satisfied for passing through the route with the movement cost D within the time length T, obtain an occurrence probability of a speed equal to or faster than the speed D/T using a cumulative distribution function of the normal distribution, and treat the obtained occurrence probability as an output of pr(D, T). A function PRₜ(k) is expressed using the function pr(D, T) as indicated in [Formula 11].

PRₜ(k)=pr(Dₜ(k),Tₜ(k)) [Formula 11]

Dₜ(k) is the movement cost from the position of the camera 10 corresponding to the camera ID of Rₜ[k−1] to the position of the camera 10 corresponding to the camera ID of Rₜ[k]. As this movement cost, the movement route estimation unit 505 may adopt the movement cost, which is obtained when the camera relation map is created, of the shortest distance between these cameras 10 or may use the movement cost of a route obtained by performing a path search taking into consideration that a frequently used route is passed through. Tₜ(k) is a difference value obtained by subtracting the capture time of Rₜ[k−1] from the capture time of Rₜ[k].

In addition, it is considered that in many cases the estimation target person does not move forward and backward on a route, that is, the estimation target person tends not to reappear at the position of the camera 10 after passing this position once. Based on this line of thinking, the movement route estimation unit 505 may refer to history information indicating the positions of the cameras 10 that have been passed and adjust the movement cost to the position of the camera 10 to be the next movement destination. As a specific example, when obtaining a movement cost Dₜ(k), if the camera ID of Rₜ[k] matches at least the camera ID of one of Rₜ[0] to Rₜ[k−2] and differs from the camera ID of Rₜ[k−1], the movement route estimation unit 505 may adjust the movement cost Dₜ(k) so that it is less likely to be judged that the estimation target person has moved from Rₜ[k−1] to Rₜ[k]. Alternatively, the movement route estimation unit 505 may adjust the movement cost Dₜ(k) based on the camera IDs of Rₜ[0] to Rₜ[k−1] and the camera ID of Rₜ[k] according to a predetermined rule based on another line of thinking.

As described above, the movement route estimation unit 505 can obtain the likelihood Lₜ for each route candidate Rₜ.

(Step S208)

The movement route estimation unit 505 outputs, as a movement route estimation result, a route candidate Rₜ corresponding to a relatively large likelihood Lₜ to the estimation control unit 503. The movement route estimation unit 505 may output only the route candidate Rₜ corresponding to the highest likelihood Lₜ, or may output a plurality of route candidates Rₜ corresponding to a plurality of the highest likelihoods Lₜ. When the movement route estimation unit 505 outputs a plurality of route candidates Rₜ, the movement route estimation unit 505 may output the route candidates Rₜ taking into consideration not only the magnitudes of the likelihoods Lₜ but also a condition such as the number of elements of the search result shared among the route candidates Rₜ to be output be as small as possible, or may classify the route candidates according to conditions such as long, medium, and short route lengths and output the route candidate Rₜ corresponding to the highest likelihood Lₜ in each class.

The movement route estimation unit 505 may exhaustively generate route candidates, or in order to speed up processing, may use the Monte Carlo method to randomly generate route candidates and select an optimum route candidate from the generated route candidates. Alternatively, the movement route estimation unit 505 may use an exploratory approach to sequentially determine an element of the search result to be adopted next while evaluating a likelihood for each partial route candidate.

(Step S209)

The estimation control unit 503 receives the output of the movement route estimation unit 505, and based on the received output, determines whether a search termination condition is satisfied.

If the search termination condition is satisfied, the movement route estimation system 90 terminates the movement route estimation process based on the current request message, and returns to step S201 via step S210.

Specific examples of the search termination condition are indicated below, where loop processing is processing from step S204 to step S208.
The movement route estimation device 50 has searched the entire searchable range by the loop processing up to the current time.
The movement route estimation device 50 has searched the entire pre-specified search range by the loop processing up to the current time.
There is no route candidate output by the movement route estimation unit 505, or the likelihood of the route candidate is equal to or lower than a predetermined threshold value.
The route candidate output by the movement route estimation unit 505 is a route indicating that the estimation target person has moved to the outside of the target space.
A predetermined time period has elapsed since the start of the movement route estimation process, the amount of memory used by the movement route estimation process has exceeded a predetermined value, or the operational amount of the movement route estimation process has exceeded a predetermined value.

If the search termination condition is not satisfied, the movement route estimation device 50 returns to step S204, and executes processing of step S204 to step S208 again. In step S204 that is executed next, the estimation control unit 503 sets the starting position of a search using the position and time of the camera 10 at the end point of the route candidate indicated by the result output by the movement route estimation unit 505 in step S208 of the immediately preceding loop processing, as indicated in (b) of FIG. 7 and (c) of FIG. 7. The arrow in (b) of FIG. 7 indicates the route candidate estimated by one loop of the loop processing, and (c) of FIG. 7 indicates a situation where the end point of the route candidate estimated by the immediately preceding loop processing is set as the starting position.

When there are a plurality of movement route candidates output by the movement route estimation unit 505, the movement route estimation device 50 may set a plurality of starting positions respectively corresponding to the plurality of route candidates, and execute the processing of step S204 to step S208 for each starting position of the plurality of starting positions that are set.

***Description of Effects of Embodiment 1***

As described above, according to this embodiment, by generating a plurality of route candidates and using the generated route candidates to estimate a movement route of a target person, the movement route of the target person can be estimated without sequentially tracking the target person.

In a process of identifying a person using a feature value that can be acquired from an image, a problem is that the accuracy of identifying the same person is relatively low. In particular, when an identification process is performed using appearance features of the whole body of a person, erroneous identification, in which of a person with similar clothing is erroneously identified, and identification omission, in which the person to be identified is not identified, often occur. The more people gather in a space, the more frequently this erroneous identification problem occurs, and if many erroneous identification results are included in a search result, it is difficult to find the person being searched for. Therefore, in a method of sequentially estimating a movement route, a problem is that estimation of a movement route fails relatively often.

In this embodiment, a search for the target person is performed in recorded videos in a fixed temporal range and a fixed spatial range, and a plurality of route candidates are generated based on a plurality of search results obtained by the search, and a movement route of the target person is estimated based on an estimated likelihood for each of the generated route candidates. Therefore, according to this embodiment, a movement route can be estimated while reducing the influence of erroneous identification and identification omission that occur locally.

***Other Configurations***

### <Variation 1>

At least one of the information I2 and the information I3 may be omitted in a request message.

A process of obtaining the starting point by the estimation control unit 503 in step S204 in this variation will be described below.

If position information of the information I2 is not included in a request message and is not input to the estimation control unit 503, the estimation control unit 503 performs a person search using the feature management device 40, using search target feature values input from the search feature extraction unit 502, with regard to all the cameras 10. In this case, the estimation control unit 503 may limit the search time width to the vicinity of the time indicated by the information I3.

If the information I2 is input and the information I3 is not input, the estimation control unit 503 performs a search encompassing the cameras 10 in the vicinity of the information I2 and all time slots.

If neither the information I2 nor the information I3 is input, a search is performed encompassing all the cameras 10 and all time slots.

The estimation control unit 503 extracts a search result with the highest reliability from among search results with reliabilities equal to or higher than a predetermined threshold value, and sets, as the starting point of the search, at least one of the time and position included in the extracted search result. Alternatively, the estimation control unit 503 may extract a plurality of starting points in descending order of reliability from the search result, and instruct that a route candidate be estimated for each of the extracted starting points.

### <Variation 2>

The estimation control unit 503 may perform a search encompassing all the cameras 10 and all the time slots corresponding to videos captured by all the cameras 10 without specifying a search range. Alternatively, the estimation control unit 503 may limit the cameras 10 to be used to the cameras 10 located within a fixed range without setting a search target time, or may treat all the cameras 10 as the cameras 10 to be used and set a search target time.

### <Variation 3>

When estimating a likelihood, the movement route estimation unit 505 may estimate the position of a person in the target space based on video data and use the estimated position, instead of using the position of a camera node as the position of the person. If an obstacle or the like considered as a hindrance to movement of the person is captured around the person in video data, the movement route estimation unit 505 may take into consideration the influence of the obstacle or the like on the movement of the person.

According to this variation, the movement route estimation unit 505 can obtain a likelihood with higher accuracy.

### <Variation 4>

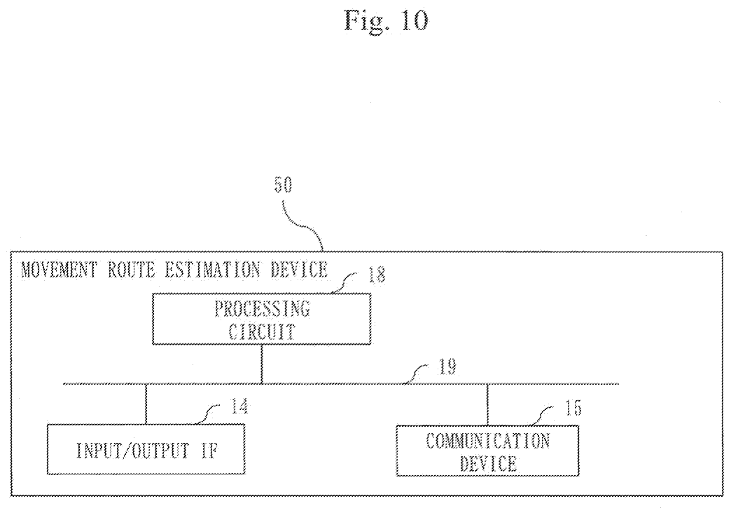

FIG. 10 illustrates an example of a hardware configuration of the movement route estimation device 50 according to this variation.

As illustrated in this figure, the movement route estimation device 50 includes a processing circuit 18 in place of the processor 11, in place of the processor 11 and the memory 12, in place of the processor 1I and the auxiliary storage device 13, or in place of the processor 11, the memory 12, and the auxiliary storage device 13.

The processing circuit 18 is hardware that realizes at least part of the units included in the movement route estimation device 50.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The movement route estimation device 50 may include a plurality of processing circuits as an alternative to the processing circuit 18. The plurality of processing circuits share the role of the processing circuit 18.

In the movement route estimation device 50, some functions may be realized by dedicated hardware, and the remaining functions may be realized by software or firmware.

As a specific example, the processing circuit 18 is realized by hardware, software, firmware, or a combination of these.

The processor 11, the memory 12, the auxiliary storage device 13, and the processing circuit 18 are collectively called “processing circuitry”. That is, the functions of the functional components of the movement route estimation device 50 are realized by the processing circuitry.

### OTHER EMBODIMENTS

Embodiment 1 has been described, and portions of this embodiment may be implemented in combination. Alternatively, this embodiment may be partially implemented. Alternatively, this embodiment may be modified in various ways as necessary, and may be implemented as a whole or partially in any combination.

The embodiment described above is an essentially preferable example, and is not intended to limit the present disclosure as well as the applications and scope of uses of the present disclosure. The procedures described using the flowcharts or the like may be modified as appropriate.

### REFERENCE SIGNS LIST

11: processor; 12: memory; 13: auxiliary storage device; 14: input/output IF; 15: communication device; 18: processing circuit; 19: signal line; 10: camera; 20: hub; 30: feature extraction device: 301: video data acquisition unit; 302: object detection unit; 303: object feature extraction unit; 40: feature management device; 401: object feature acquisition unit; 402: database input unit; 403: search request acquisition unit; 404: database search unit; 405: search result output unit; 406: database; 50: movement route estimation device; 501: route estimation request acquisition unit; 502: search feature extraction unit; 503: estimation control unit; 504: object search unit: 505: movement route estimation unit; 90: movement route estimation system; I1, I2, I3: information.

1. A movement route estimation device that uses data managed by a feature management device, the feature management device treating, as a target feature value, each object feature value of a plurality of object feature values extracted from a plurality of videos captured of part of a target space in a target period, and managing the target feature value in association with a capture time that indicates a time of capture of a video from which the target feature value is extracted,
the target feature value being a feature value extracted from one of the plurality of videos, and indicating a feature of one object of one or more objects,
the movement route estimation device comprising
processing circuitry to:
search for, as a search feature value, each feature value of two or more feature values from among the plurality of object feature values, based on a similarity between a feature value corresponding to a movable object and the target feature value, the movable object being an object that has moved in the target space in the target period; and
obtain a plurality of route candidates and a plurality of likelihoods respectively corresponding to the plurality of route candidates, based on a capture time corresponding to the search feature value and a position of presence of an object corresponding to the search feature value at the capture time corresponding to the search feature value, the plurality of route candidates indicating candidates for a corresponding route that corresponds to a route, in the target space, on which the movable object has moved in the target period, and estimate the corresponding route from the plurality of route candidates, depending on the obtained likelihoods.

2. The movement route estimation device according to claim 1,
wherein the processing circuitry obtains a plurality of realization probabilities respectively corresponding to the plurality of route candidates, based on the capture time corresponding to the search feature value and the position of presence of the object corresponding to the search feature value at the capture time corresponding to the search feature value, and obtains the plurality of likelihoods respectively corresponding to the plurality of route candidates based on the obtained realization probabilities.

3. The movement route estimation device according to claim 1,
wherein the processing circuitry obtains the plurality of likelihoods respectively corresponding to the plurality of route candidates, based on a speed assumed as a speed of movement of the movable object on each of a plurality of routes respectively corresponding to the plurality of route candidates.

4. The movement route estimation device according to claim 1,
wherein the processing circuitry obtains the plurality of likelihoods respectively corresponding to the plurality of route candidates, based on a similarity between the feature value corresponding to the movable object and the search feature value.

5. The movement route estimation device according to claim 1,
wherein the processing circuitry obtains each of the plurality of route candidates, using a camera relation map, the camera relation map being a graph generated based on a map of the target space and positions of areas captured in each of the plurality of videos.

6. The movement route estimation device according to claim 5,
wherein the processing circuitry obtains the plurality of likelihoods respectively corresponding to the plurality of route candidates, based on a movement cost that indicates a cost of movement of the movable object between nodes in the camera relation map.

7. The movement route estimation device according to claim 1,
wherein each object of the one or more objects is a person.

8. A movement route estimation method that uses data managed by a feature management device, the feature management device treating, as a target feature value, each object feature value of a plurality of object feature values extracted from a plurality of videos captured of part of a target space in a target period, and managing the target feature value in association with a capture time that indicates a time of capture of a video from which the target feature value is extracted,
the target feature value being a feature value extracted from one of the plurality of videos, and indicating a feature of one object of one or more objects,
the movement route estimation method comprising:
searching for, as a search feature value, each feature value of two or more feature values from among the plurality of object feature values, based on a similarity between a feature value corresponding to a movable object and the target feature value, the movable object being an object that has moved in the target space in the target period; and
obtaining a plurality of route candidates and a plurality of likelihoods respectively corresponding to the plurality of route candidates, based on a capture time corresponding to the search feature value and a position of presence of an object corresponding to the search feature value at the capture time corresponding to the search feature value, the plurality of route candidates indicating candidates for a corresponding route that corresponds to a route, in the target space, on which the movable object has moved in the target period, and estimating the corresponding route from the plurality of route candidates, depending on the obtained likelihoods.

9. A non-transitory computer readable medium storing a movement route estimation program that uses data managed by a feature management device, the feature management device treating, as a target feature value, each object feature value of a plurality of object feature values extracted from a plurality of videos captured of part of a target space in a target period, and managing the target feature value in association with a capture time that indicates a time of capture of a video from which the target feature value is extracted,
the target feature value being a feature value extracted from one of the plurality of videos, and indicating a feature of one object of one or more objects,
the movement route estimation program causing a movement route estimation device, which is a computer, to execute:
an object search process of searching for, as a search feature value, each feature value of two or more feature values from among the plurality of object feature values, based on a similarity between a feature value corresponding to a movable object and the target feature value, the movable object being an object that has moved in the target space in the target period; and
a movement route estimation process of obtaining a plurality of route candidates and a plurality of likelihoods respectively corresponding to the plurality of route candidates, based on a capture time corresponding to the search feature value and a position of presence of an object corresponding to the search feature value at the capture time corresponding to the search feature value, the plurality of route candidates indicating candidates for a corresponding route that corresponds to a route, in the target space, on which the movable object has moved in the target period, and estimating the corresponding route from the plurality of route candidates, depending on the obtained likelihoods.
